(19) United States
(12) Patent Application Publication
(10) Pub. No.: US 2018/0213750 A1
(43) Pub. Date: Aug. 2, 2018

(54) Portable Chicken Roost and Method

(71) Applicant: James Koskey, Manitou Springs, CO (US)

(72) Inventor: James Koskey, Manitou Springs, CO (US)

(21) Appl. No.: 14/962,047

(22) Filed: Dec. 8, 2015

(51) Int. Cl. A01K 31/12; H05B 3/42

(52) U.S. Cl. CPC A01K 31/12; A01K 31/20; H05B 3/42

(57) ABSTRACT

A portable chicken roost has a number of detachable legs. The detachable legs connect to a number of attachment points on a roosting bar. An electrical heater is inside the roosting bar and electrically connected to an interior thermostat inside the roosting bar. An exterior thermostat is also attached to the electrical heater and located outside the roosting bar. The interior thermostat and the exterior thermostat are connected in series electrically, and the temperature setting of the exterior thermostat is different than the interior thermostat. This roosting bar protects chicken's feet from freezing and breaks down for easy shipping and transporting.

### BACKGROUND OF THE INVENTION

Raising chickens in urban settings has become quite popular, because of people's desire for fresh eggs and because chickens make good pets. Chickens like other birds like to perch or roost when sleeping. This is a natural instinct for keeping them safe from predators. Most roosting bars are just a small branch, or a wooden dowel held off the ground. However, when it is cold outside the chicken's feet may freeze while they are perched on the roosting bar at night.

Thus there exists a need for a heated roosting bar for chickens.

### BRIEF SUMMARY OF INVENTION

A portable chicken roost that overcomes these and other problems has a number of detachable legs. The detachable legs connect to a number of attachment points on a roosting bar. An electrical heater is inside the roosting bar and electrically connected to an interior thermostat inside the roosting bar. An exterior thermostat is also attached to the electrical heater located outside the roosting bar. The interior thermostat and the exterior thermostat are connected in series electrically, and the temperature setting of the exterior thermostat is different than the interior thermostat.

This roosting bar protects chicken's feet from freezing and breaks down for easy shipping and transporting.

### BRIEF DESCRIPTION OF THE SEVERAL VIEWS OF THE DRAWINGS

FIG. 1 is a cartoon drawing of a chicken in a coop on a portable chicken roost in accordance with one embodiment of the invention;

FIG. 2 is a front view of a portable chicken roost in a use position in accordance with one embodiment of the invention;

FIG. 3 is a top view of a portable chicken roost in a shipping position in accordance with one embodiment of the invention;

FIG. 4 is a schematic drawing of the heater circuit for the portable chicken roost in accordance with one embodiment of the invention;

FIG. 5 is a cross sectional view of a roosting bar in accordance with one embodiment of the invention;

FIG. 6 is a flow chart of the steps used in a method of operating a portable chicken roost in accordance with one embodiment of the invention.

### DETAILED DESCRIPTION OF THE INVENTION

A portable chicken roost has a number of detachable legs. The detachable legs connect to a number of attachment points on a roosting bar. An electrical heater is inside the roosting bar and electrically connected to an interior thermostat inside the roosting bar. An exterior thermostat is also attached to the electrical heater located outside the roosting bar. The interior thermostat and the exterior thermostat are connected in series electrically, and the temperature setting of the exterior thermostat is different than the interior thermostat. This roosting bar protects chicken's feet from freezing and breaks down for easy shipping and transporting.

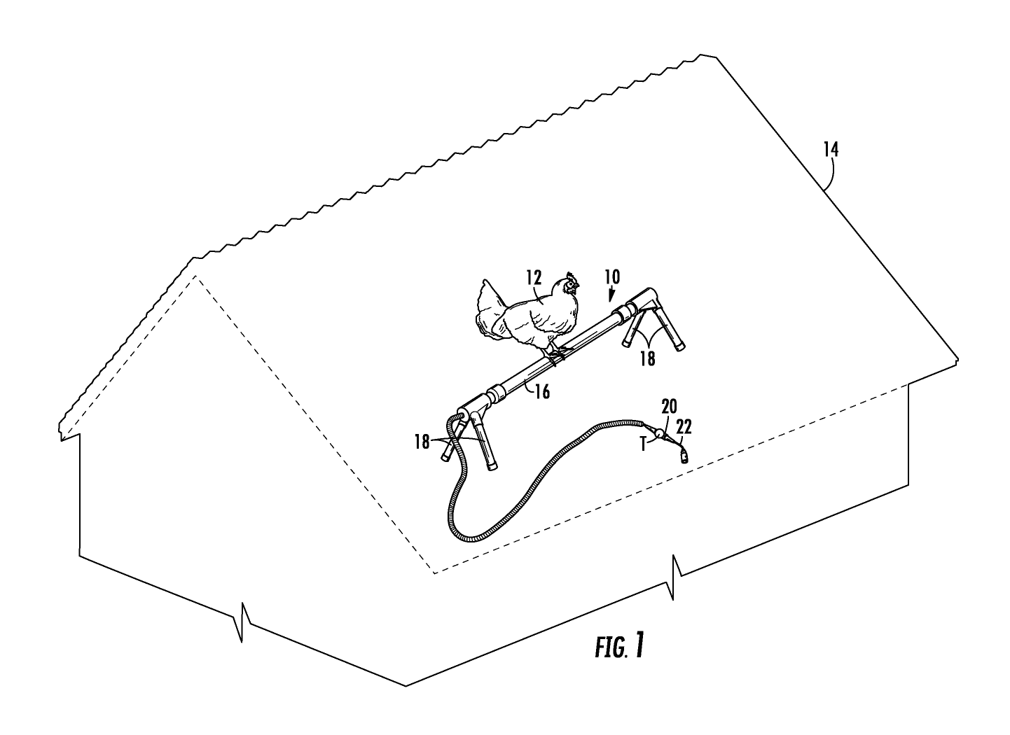

FIG. 1 is a cartoon drawing of a chicken 12 in a coop 14 on a portable chicken roost 10 in accordance with one embodiment of the invention. The chicken roost 10 has a roosting bar 16 attached to a plurality of legs 18 and an electrical heater (not shown) disposed inside the roosting bar 16. Note that the heater includes an external thermostat 20 attached to an electrical cord 22. Ideally the external thermostat 20 is outside of the coop 14 or is exposed to the ambient temperature.

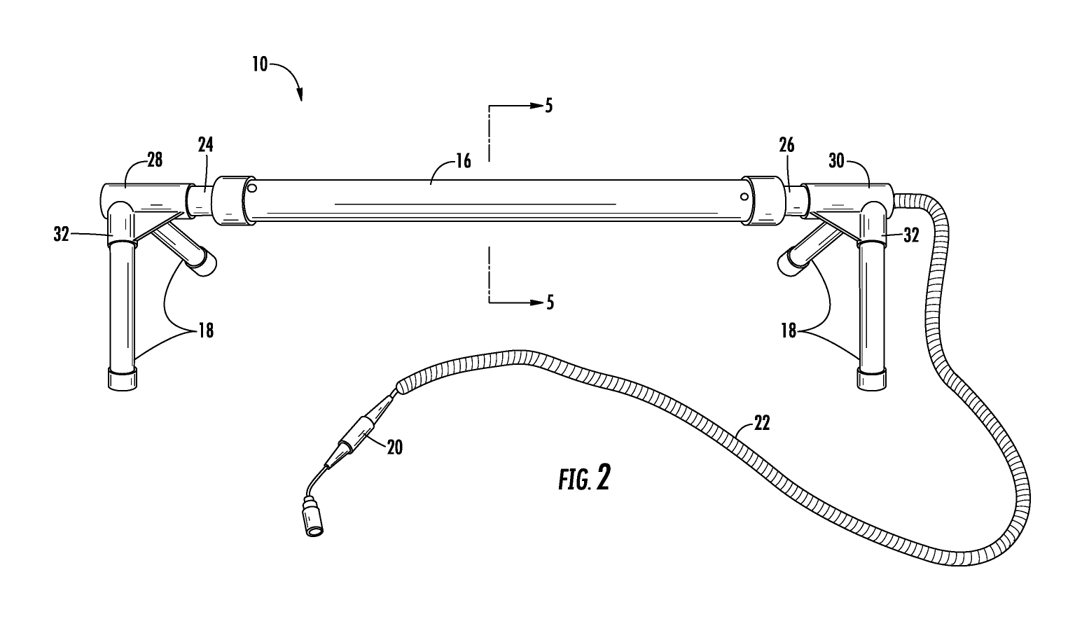

FIG. 2 is a front view of a portable chicken roost 10 in a use position in accordance with one embodiment of the invention. The roosting bar 16 has first end 24 and a second end 26. A first Y joint 28 is attached to a first end 24 of the roosting bar 16. A second Y joint 30 is attached to a second end 26 of the roosting bar 16. An electrical cord 22 extends out of the second Y joint 30. The Y joints 28, 30 have a number of attachment points 32. In one embodiment, the legs 18 slide into the Y joints' 28, 30 attachment points 32. Those skilled in the art will understand that many methods may be used to attach the legs 18 to the roosting bar 16, including screws, bolts, pins and many others all of these are contemplated by the invention.

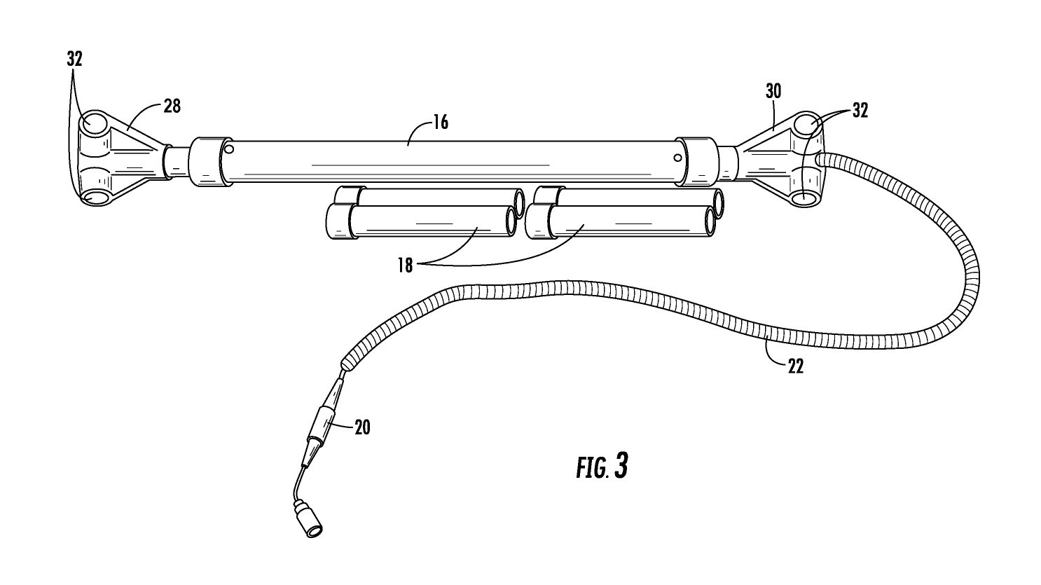

FIG. 3 is a top view of portable chicken roost 10 in a shipping position in accordance with one embodiment of the invention. The position shows the legs 18 are easily detached and in this position the portable chicken roost 10 conveniently fits in a box for shipping. A major part of the cost of many devices is the cost of shipping and the larger the package the more expensive it is to ship. This also is an advantage for the owner if they are personally transporting the chicken roost 10. The roosting bar may be made of metal, which provides good heat conduction If the roosting bar is made of metal it may be powder coated to provide a friction surface for the chickens to grab onto. In another embodiment, the roosting bar 16 is made of a polymer and may be injection molded. The legs and connectors may also be made of a polymer or steel. The roosting bar may have an oval cross section.

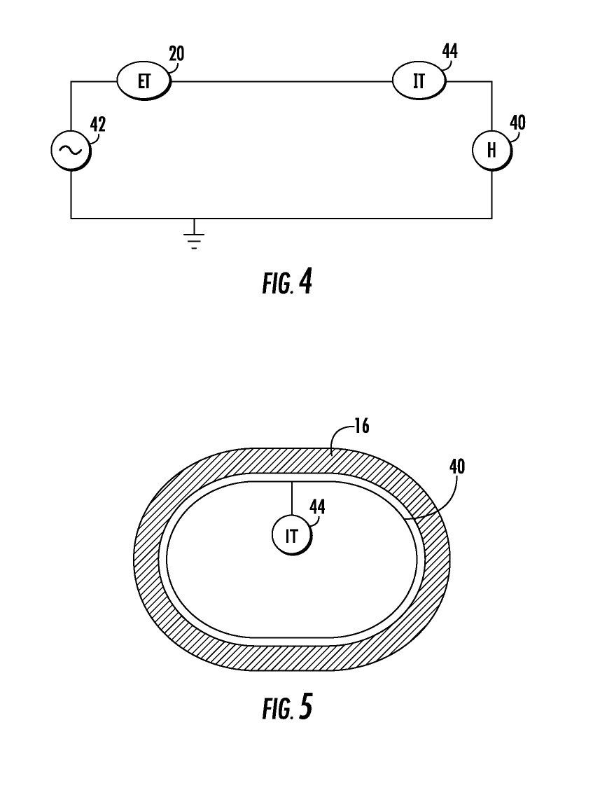

FIG. 4 is a schematic drawing of the heater circuit for the portable chicken roost in accordance with one embodiment of the invention. The heater 40 is connected to a power source 42, which is shown as an AC voltage source but could be a DC voltage source. An external thermostat 20 is in series with an internal thermostat 44. The internal thermostat 44 is inside the roosting bar 16. The external thermostat 20 is designed to measure the ambient temperature. In one embodiment, the internal thermostat is set to the body temperature of a chicken or about 110 degrees Fahrenheit. The external thermostat 20 is set just above freezing or about 35 degrees Fahrenheit. The external thermostat 20 makes sure that the heater is not activated unless it is necessary, which saves the owner electricity. The internal thermostat makes sure the temperature of the roosting bar is about the body temperature of a chicken.

FIG. 5 is a cross sectional view of roosting bar in accordance with one embodiment of the invention. In one embodiment, the heating element 40 is a thermal wire, which may by encapsulated in foil. The heating element 40 is attached to the inside of the roosting bar 16. In another embodiment the heating element 40 is placed inside the roosting bar 16 material. The internal thermostat 44 is in the roosting bar 16. In another embodiment, the thermostat 44 is placed inside the roost bar 16 material.

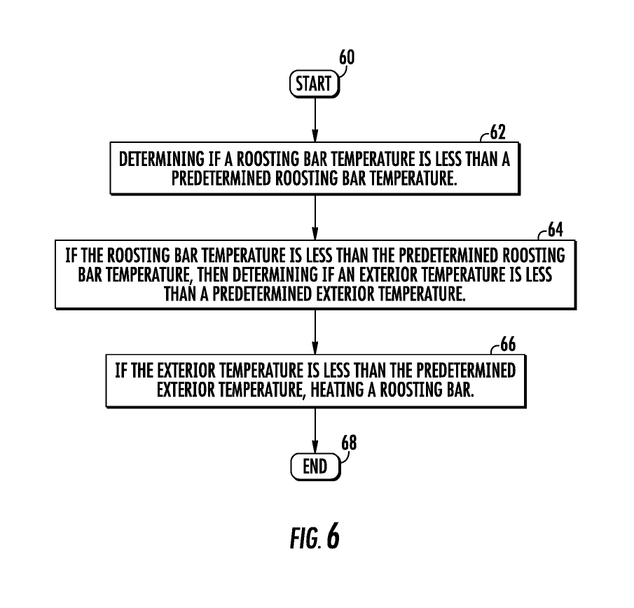

FIG. 6 is a flow chart of the steps used method of operating a portable chicken roost in accordance with one embodiment of the invention. The process starts, step 60, by determining if a roosting bar temperature is less than a predetermined roosting bar temperature at step 62. When the roosting bar temperature is less than the predetermined roosting bar temperature, then it is determined if an exterior temperature is less than a predetermined exterior temperature at step 64. When the exterior temperature is less than the predetermined exterior temperature, step 66, a roosting bar is heated, which end the process, step 68.

Thus there has been described a portable roosting bar that keeps chickens' feet from freezing and is inexpensive to manufacture and ship. While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A portable chicken roost, comprising:
a plurality of legs;
a roosting bar having a plurality of attachment points for detachably connecting to the plurality of legs;
an electrical heater inside the roosting bar; and
an interior thermostat attached to the electrical heater located inside the roosting bar.

2. The portable chicken roost of claim 1, wherein the roosting bar has a center section made of a metal.

3. The portable chicken roost of claim 2, wherein the plurality of attachment points include a pair of Y joints.

4. The portable chicken roost of claim 3, wherein the plurality of legs have an attachment end that slides into a finger of the pair of Y joints.

5. The portable chicken roost of claim 1, further including a power cord electrically connected to the interior thermostat.

6. The portable chicken roost of claim 5, further including an exterior thermostat electrically connected to the power cord and physically located on the power cord outside the roosting bar.

7. The portable chicken roost of claim 6, wherein the interior thermostat and the exterior thermostat are connected in series electrically.

8. The portable chicken roost of claim 7, wherein a temperate setting of the exterior thermostat is different than the interior thermostat.

9. The portable chicken roost of claim 7, wherein the interior thermostat is set at a temperature of at least 110 degrees Fahrenheit.

10. The portable chicken roost of claim 7, wherein the exterior thermostat is set at a temperature of about 32 degrees Fahrenheit.

11. The portable chicken roost of claim 1, wherein the chicken roost has a shipping position and a use position.

12. A method of operating a portable chicken roost comprising the steps of:
determining if a roosting bar temperature is less than a predetermined roosting bar temperature;
if the roosting bar temperature is less than the predetermined roosting bar temperature, then determining if an exterior temperature is less than a predetermined exterior temperature; and
if the exterior temperature is less than the predetermined exterior temperature, heating a roosting bar.

13. The method of claim 12, wherein the step of heating the roosting bar includes the step of applying a voltage to an electrical heater attached to the roosting bar.

14. The method of claim 12, further including the steps of if the roosting bar temperature is not less than the predetermined roosting bar temperature, then not heating the roosting bar.

15. The method of claim 12, further including the steps of if the exterior temperature is not less than the predetermined exterior temperature, then not heating the roosting bar.

16. The method of claim 12, further including the step of attaching a plurality of legs to a roosting bar.

17. The method of claim 12, wherein the step of determining if the roosting bar temperature is less than the predetermined roosting bar temperature, includes the step of setting the predetermined roosting bar temperature to approximately 110 degree Fahrenheit.

18. The method of claim 12, wherein the step of determining if the exterior temperature is less than the predetermined exterior temperature, includes the step of setting the predetermined exterior temperature to approximately 35 degree Fahrenheit.

19. A portable chicken roost, comprising:
a plurality of detachable legs; and
a roosting bar having a plurality of attachment points for detachably connecting to the plurality of detachable legs.

20. The portable chicken roost of claim 19, further including
an electrical heater inside the roosting bar;
an exterior thermostat attached to the electrical heater located outside the roosting bar;
an interior thermostat inside the roosting bar, wherein the interior thermostat and the exterior thermostat are connected in series electrically, wherein a temperate setting of the exterior thermostat is different than the interior thermostat.
